(19) United States
(12) Patent Application Publication
(10) Pub. No.: US 2026/0359349 A1
(43) Pub. Date: Nov. 12, 2026

(54) INFORMATION PROCESSING APPARATUS, INFORMATION PROCESSING METHOD, COMPUTER PROGRAM, AND GENERATION SYSTEM

(71) Applicant: Sony Group Corporation, Tokyo (JP)

(72) Inventors: Mengjie ZHAO, Tokyo (JP); Hiromi KURASAWA, Tokyo (JP)

(73) Assignee: Sony Group Corporation, Tokyo (JP)

(21) Appl. No.: 19/486,961

(22) PCT Filed: Apr. 15, 2024
(86) PCT No.: PCT/JP2024/014963

§ 371 Date: Nov. 24, 2025

(30) Foreign Application Priority Data
Jun. 5, 2023 (JP) 2023-092300

(51) Int. Cl. G06F 16/535; G06F 16/532; G06F 16/56; G06T 11/00

(52) U.S. Cl. CPC G06F 16/535; G06F 16/532; G06F 16/56; G06T 11/00

(57) ABSTRACT

Provided is an information processing apparatus that converts a sentence uttered by a human into prompt data more preferable for a model by obtaining correspondence between text data including natural written expression and the prompt data via image data. An information processing apparatus includes an acquisition unit that acquires text data, an image search unit that searches for image data corresponding to first vector data on the basis of the first vector data obtained by converting the text data, and a prompt search unit that searches for prompt data corresponding to second vector data on the basis of the second vector data obtained by converting the image data.

### TECHNICAL FIELD

The technology disclosed in the present specification (hereinafter, referred to as “the present disclosure”) relates to an information processing apparatus, an information processing method, a computer program, and a generation system that perform processing for effectively using a model.

### BACKGROUND ART

In recent years, image data can be generated from text data by a text-to-image technology as one of generative artificial intelligence (AI). This type of image generative AI learns a large number of pairs of an explanatory sentence attached to an image called a caption and image data, so that it is possible to generate an image close to what it means by input using text data including a natural written expression. For example, the image generative AI can generate image data of various expressions matching the instructed semantic content from sentences such as “a black bird with a red beak is perched on a tree” or “a large blue bird flutters in the sky”. Examples of the image generative AI include Stable Diffusion and DALL-E2.

Although the technological innovation of AI has remarkably evolved, this is still developing, and various problems are arising. A problem that has recently attracted attention in particular is prompt engineering. This means that, when a human gives an instruction to an AI model (hereinafter, also simply referred to as a “model”) about a target to be generated, the representation of prompt data, which is an instruction to be input to the model, is devised so that a product can be more easily controlled and a better result can be obtained than when text data including a natural written expression is input as it is. Generally, training a model requires a great cost, but training of a large-scale model with a large resource is performed in order to enhance versatility and ability that can be obtained only by increasing the scale. In contrast, prompt engineering is to obtain a better result only by devising the expression of the prompt data without retraining a trained model while keeping internal parameters thereof fixed. The prompt engineering has attracted attention as an effective utilization method of a large-scale model. For example, a technology of converting a human input into prompt data using a language model learned by reinforcement learning using aesthetic and relevance scores as rewards has been proposed (refer to Non-Patent Document 1).

### CITATION LIST

### Non-Patent Document

Non-Patent Document 1: Optimizing Prompts for Text-to-Image Generation <https://arxiv.org/abs/2212.09611>
Non-Patent Document 2: DIFFUSIONDB: A Large-scale Prompt Gallery Dataset for Text-to-Image Generative Models <https://arxiv.org/pdf/2210.14896.pdf>
Non-Patent Document 3: Learning Transferable Visual Models From Natural Language Supervision <https://arxiv.org/pdf/2103.00020.pdf>
Non-Patent Document 4: CYCLIP: Cyclic Contrastive Language-Image Pretraining <https://arxiv.org/pdf/2205.14459.pdf>

### SUMMARY OF THE INVENTION

### Problems to be Solved by the Invention

An object of the present disclosure is to provide an information processing apparatus, an information processing method, a computer program, and a generation system that implement efficient use of a model by devising prompt data.

### Solutions to Problems

The present disclosure has been made in view of the above-described problem, and a first aspect thereof is
an information processing apparatus including:
an acquisition unit that acquires text data;
an image search unit that searches for image data corresponding to first vector data on the basis of the first vector data obtained by converting the text data; and
a prompt search unit that searches for prompt data corresponding to second vector data on the basis of the second vector data obtained by converting the image data.

The text data is converted into the first vector data using a text encoder of a previously trained vision-language (VL) model. The image search unit searches for image data paired with vector data having high similarity with the first vector data in a first database that stores a pair of image data and vector data.

Furthermore, the image data searched by the image search unit is converted into the second vector data using an image encoder of a previously trained VL model. The prompt search unit searches for prompt data paired with vector data having high similarity with the second vector data in a second database that stores a pair of prompt data and vector data.

Furthermore, a second aspect of the present disclosure is
an information processing method including:
an acquisition step of acquiring text data;
an image searching step of searching for image data corresponding to first vector data on the basis of the first vector data obtained by converting the text data; and
a prompt searching step of searching for prompt data corresponding to second vector data on the basis of the second vector data obtained by converting the image data.

Furthermore, a third aspect of the present disclosure is a computer program described in a computer readable format to cause a computer to function as:
an acquisition unit that acquires text data;
an image search unit that searches for image data corresponding to first vector data on the basis of the first vector data obtained by converting the text data; and
a prompt search unit that searches for prompt data corresponding to second vector data on the basis of the second vector data obtained by converting the image data.

The computer program according to the third aspect of the present disclosure is obtained by defining a computer program described in a computer readable format so as to implement predetermined processing on a computer. The computer program can be provided for a computer capable of executing various program codes by a storage medium provided in a computer readable format, a communication medium, a storage medium such as an optical disk, a magnetic disk, or a semiconductor memory, for example, or a communication medium such as a network. Then, by installing the computer program according to the third aspect of the present disclosure in a computer via any of the media, a cooperative action is exerted on the computer, and operational effects similar to those of the information processing apparatus according to the first aspect of the present disclosure can be achieved.

Furthermore, a fourth aspect of the present disclosure is
a generation system including:
an acquisition unit that acquires text data;
a previously trained VL model including a text encoder and an image encoder;
a first database that stores a pair of image data and vector data;
a second database that stores a pair of prompt data and vector data;
an image search unit that searches the first database for image data paired with vector data having high similarity with first vector data converted from the text data using the text encoder;
a prompt search unit that searches the second database for prompt data paired with vector data having high similarity with second vector data converted from the image data using the image encoder; and
a generation unit that inputs the prompt data searched by the prompt search unit into a trained generative model and generates information based on the prompt data.

Note that, the term “system” herein used indicates a logical assembly of a plurality of apparatuses (or functional modules that implement specific functions), and it does not matter whether or not each of the apparatuses or functional modules is in a single housing. That is, one apparatus including a plurality of components or functional modules and an assembly of a plurality of apparatuses correspond to the “system”.

### Effects of the Invention

According to the present disclosure, it is possible to provide an information processing apparatus, an information processing method, a computer program, and a generation system that convert a sentence uttered by a human into prompt data more preferable for a model by obtaining correspondence between text data including natural written expression and the prompt data via image data.

Note that, the effects described in the present specification are merely examples, and the effects to be brought by the present disclosure are not limited thereto. Furthermore, there are cases where the present disclosure further provides some additional effects, in addition to the effects described above.

Still other objects, features, and advantages of the present disclosure will become apparent from a more detailed description based on embodiments as described later and the accompanying drawings.

### BRIEF DESCRIPTION OF DRAWINGS

FIG. 1 is a diagram illustrating a functional configuration example of a prompt optimization apparatus 100.

FIG. 2 is a flowchart illustrating an example of a processing procedure performed by the prompt optimization apparatus 100.

FIG. 3 is a flowchart illustrating an example of a processing procedure performed by a preprocessing unit 102.

FIG. 4 is a diagram illustrating a configuration example of a VL model 108.

FIG. 5 is a flowchart illustrating an example of a processing procedure performed by an image search unit 103.

FIG. 6 is a flowchart illustrating an example of a processing procedure performed by a prompt search unit 104.

FIG. 7 is a diagram illustrating a use case to which the present disclosure is applied.

FIG. 8 is a flowchart illustrating a processing procedure for training the VL model 108.

FIG. 9 is a flowchart illustrating a processing procedure for creating a first database 106.

FIG. 10 is a flowchart illustrating a processing procedure for creating a second database 107.

FIG. 11 is a diagram illustrating a data example of the first database 106.

FIG. 12 is a diagram illustrating a data example of the second database 107.

FIG. 13 is a diagram illustrating a specific example in which a text vector Tₑ and an image vector Iₑ are output from a text encoder 109 and an image encoder 110, respectively.

FIG. 14 is a diagram illustrating a specific example in which text vectors Tₑ and Tₑ+ are output from the text encoder 109 with different drop masks.

FIG. 15 is a diagram illustrating processing performed at step S804 in the flowchart illustrated in FIG. 8.

FIG. 16 is a diagram illustrating a configuration example of an information processing apparatus 2000.

FIG. 17 is a diagram illustrating a use case to be compared with FIG. 7.

FIG. 18 is a diagram illustrating a cross-modal similarity matrix.

### MODE FOR CARRYING OUT THE INVENTION

Hereinafter, embodiments of the present disclosure will be described with reference to the drawings in the following order.
A. Outline
B. Assumed Use Case
C. Apparatus Configuration
D. Processing Procedure
E. Configuration of VL Model
F. Image Search Processing
G. Prompt Search Processing
H. Method of Training VL Model
I. Improvement in Method of Training VL Model
J. Method of Creating First Database
K. Method of Creating Second Database
L. Configuration of Information Processing Apparatus

### A. Outline

Prompt engineering can obtain a better result only by devising prompt data, which is an instruction to be input to a model, without retraining a trained model while keeping internal parameters thereof fixed, and has attracted attention as an effective method of utilizing a large-scale model. The prompt data, different from text data including a natural written expression, is characterized in not being an expression that is easy for a human to understand but being an expression that is easy for a model to interpret and easily guide a desired result. Therefore, there is a problem that a human needs to devise excellent prompt data through trial and error.

Recently, data of a prompt has become public. For example, a database including a large number of pairs of prompt data and image data, such as DiffusionDB (refer to Non-Patent Document 2), can be used. By looking at such database, a human might be able to learn excellent prompt data in order to obtain what is close to desired image data. However, it is desirable that anyone can generate desired image data by freely inputting text data including a natural written expression.

With a parallel corpus of a prompt and a natural language, it might be possible to train a model that converts text data including a natural written expression uttered by a human into prompt data more preferable for the model. Creation of such a corpus is time consuming and costly, as there is currently no such a corpus and this is not a naturally generated corpus.

Therefore, the present disclosure proposes a technology of searching for better prompt data by obtaining correspondence between text data including a natural written expression and prompt data by interpreting via image data. According to the present disclosure, in a situation as described above in which there is already an excellent database in which image data and prompt data are collected, but there is no excellent database in which a pair of text data including a natural written expression and prompt data preferable for a model is collected, it is possible to search for prompt data better for the model by obtaining a correspondence between the text data including a natural written expression and the prompt data by interpreting via the image data. In the present disclosure, it is possible to acquire better prompt data in a short time and at a low cost by a method via an image in which image data having high similarity with text data including a natural written expression directly input from a human is searched for, and prompt data having high similarity with the image data is further searched for.

The present disclosure is a technique of converting text data including a natural written expression into excellent prompt data via image data by using an existing image database in which image data and prompt data are collected. Therefore, the present disclosure is essentially different from a technique of directly converting a natural written expression into prompt data using a language model subjected to reinforcement training disclosed in Non-Patent Document 1.

### B. Assumed Use Case

The prompt engineering is a technology of devising an input to a trained model to obtain a better output (described above). In the present specification, an embodiment will be mainly described in which the present disclosure is applied to a generative model that generates image data from text data, and text data including a natural written expression input from a human is converted into prompt data better for the model.

“Text2X” refers to a model that generates data of various modalities from input text data. For example, Text2X generates moving image data from text data, motion data from text data, and text data from text data. Hereinafter, a use case of mainly using a Text2X (alternatively, Text-to-Image) model that generates image data from text data is assumed.

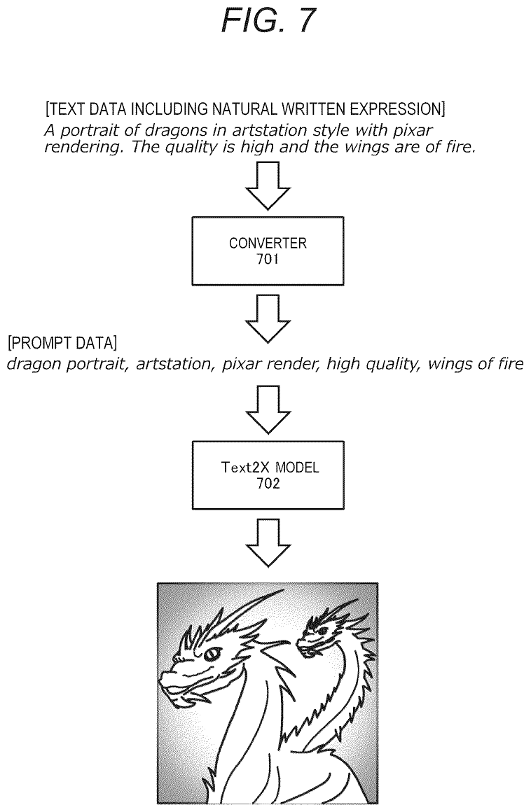

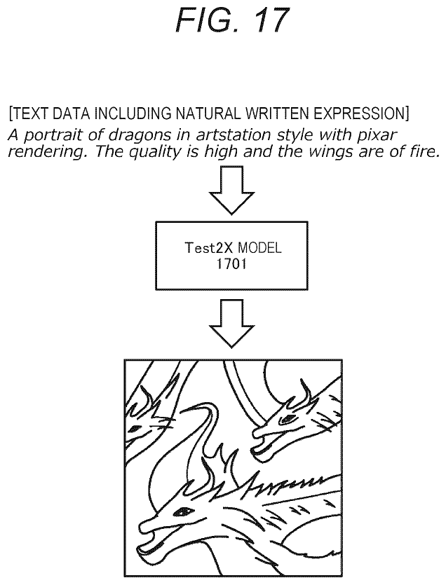

FIG. 7 illustrates a use case in which text data including a natural written expression created by a human is converted into prompt data using a converter 701 to which the present disclosure is applied, and the prompt data is input to a general Text2X model 702 to generate image data. Furthermore, FIG. 17 illustrates, as a comparison, a use case of generating image data by inputting text data including a natural written expression created by a human as it is to a general Text2X model 1701. Note that, the Test2X model 702 in FIG. 7 and the Test2X model 1701 in FIG. 17 have the same configuration.

In any of the use cases, original text data including a natural written expression is “A portrait of dragons in artstation style with pixar rendering. The quality is high and the wings are of fire”. In the example illustrated in FIG. 7, the converter 701 converts the original text data into prompt data suitable for an instruction to the model, such as “dragon portrait, artstation, pixar render, high quality, wings of fire”, and inputs the prompt data to the Text2X model 702. Therefore, even with the Text2X model having the same configuration, different image data of dragon are generated in a case where the original text data including a natural written expression is directly input to the model and in a case where the text data is converted into the prompt data suitable for the instruction to the model and then input to the model.

Here, if the excellent prompt data can be acquired by the converter 701, it is expected to generate a better image than in a case where the original text data including a natural written expression is directly input to the Text2X model. Furthermore, with the intervention of the converter 701, it is possible to generate a better image without retraining the Text2X model while fixing internal parameters thereof.

### C. Apparatus Configuration

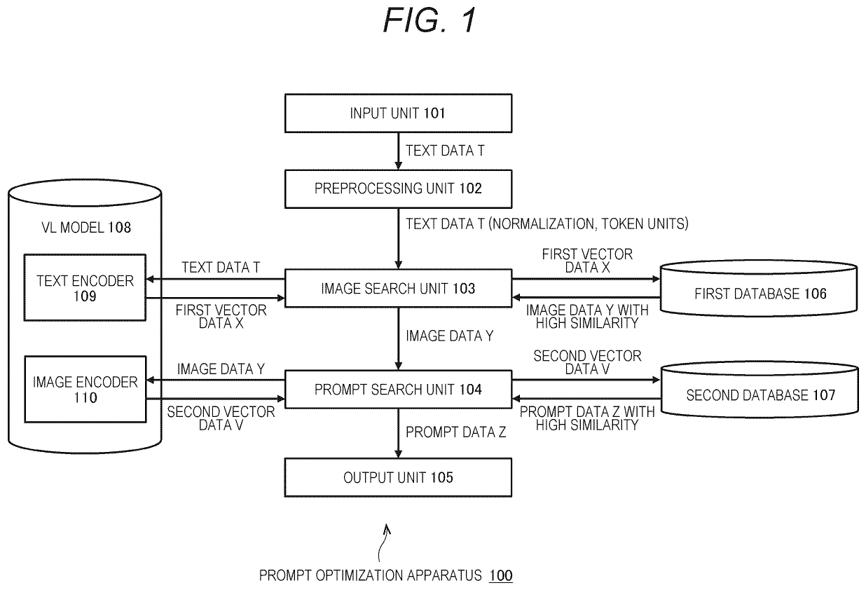

FIG. 1 illustrates a functional configuration example of a prompt optimization apparatus 100 to which the present disclosure is applied. The illustrated prompt optimization apparatus 100 has a function of converting text data including a natural written expression created by a human into better prompt data as an input to the Text2X model. The prompt optimization apparatus 100 can be applied, for example, as the converter 701 in the use case illustrated in FIG. 7. The prompt optimization apparatus 100 can be configured by using, for example, an information processing apparatus such as one or a plurality of personal computers (PCS).

The prompt optimization apparatus 100 illustrated in FIG. 1 includes an input unit 101, a preprocessing unit 102, an image search unit 103, a prompt search unit 104, and an output unit 105. Furthermore, the prompt optimization apparatus 100 uses a first database 106, a second database 107, and a VL model 108, and these components 106 to 108 may be disposed inside or outside the prompt optimization apparatus 100.

The first database 106 is a database that stores a pair of image data and vector data used by the image search unit 103 for searching for image data corresponding to text data. The vector data paired with the image data is a vector representation having the same meaning as that of the image data for a human, and can be acquired from the image data using the text encoder 109 of the previously trained VL model 108. A method of creating the first database 106 will be described later in section J to be described.

Furthermore, the second database 107 is a database that stores a pair of prompt data and vector data used by the prompt search unit 104 for searching for prompt data corresponding to image data. The vector data paired with the prompt data is a vector representation having the same meaning as that of the prompt data for a human, and can be acquired from the prompt data using the prompt encoder 110 of the previously trained VL model 108. A method of creating the second database 107 will be described later in section K to be described.

The VL model 108 is a model for simultaneously learning the image data and text data and simultaneously learning features of both, thereby interpreting the data of these two modalities in a vector space in the same manner, and includes the text encoder 109 and the image encoder 110 as illustrated in FIG. 1. When the text data and image data having the same meaning for a human are input to the previously trained VL model 108, the text encoder 109 and the image encoder 110 map the text data and the image data to the same vector data on a common (that is, with consistency between each modality of text and image) vector space, respectively. The image search unit 103 uses the text encoder 109 of the previously trained VL model 108 when converting input text data into vector data. Furthermore, when converting input image data into vector data, the prompt search unit 104 uses the image encoder 110 of the previously trained VL model 108. A method of training the VL model 108 will be described in section H to be described.

Text data including a natural written expression created by a human is input to the input unit 101 as input data to the Text2X model. The text data is, for example, a sentence such as “Dog running on green grass fetching toy bone stock”. For example, the input unit 101 may capture text data key-input by an operator via a keyboard or text data obtained by speech recognition of a sentence uttered by the operator, or may read text data recorded in a medium.

The preprocessing unit 102 performs preprocessing of normalizing the text data input to the input unit 101 or dividing the text data into units called tokens. Normalization and tokens will be described later. The preprocessing unit 102 outputs text data although notation might change.

The image search unit 103 converts the text data output from the preprocessing unit 102 into first vector data X by the text encoder 109, searches the first database 106 with the first vector data, and outputs image data Y paired with vector data having high similarity with the first vector data X.

The prompt search unit 104 converts the image obtained by the image search unit 103 into a second vector data V by the image encoder 110, searches the second database 107 with the second vector data V, and outputs prompt data Z paired with vector data having high similarity with the second vector data V.

The output unit 105 outputs the prompt data Z obtained by the prompt search unit 104 to the outside of the prompt optimization apparatus 100. For example, the prompt data “Small puppy, running, park, green grass” obtained for the input text data “Dog running on green grass fetching toy bone stock” is output.

The prompt data output from the output unit 105 is input to, for example, a Text2X model (not illustrated). The prompt data output from the output unit 105 is easily interpreted by the Text2X model, and as a result, the Text2X model easily generates the image data desired by the user.

In short, the prompt optimization apparatus 100 has a configuration of obtaining the prompt data that is easily interpreted by the Text2X model via the image data having high semantic similarity with the text data including a natural written expression directly input from a human. The prompt optimization apparatus 100 can convert the text data including a natural written expression into the prompt data in a short time and at a low cost by effectively utilizing an existing database obtained by collecting image data and prompt data.

### D. Processing Procedure

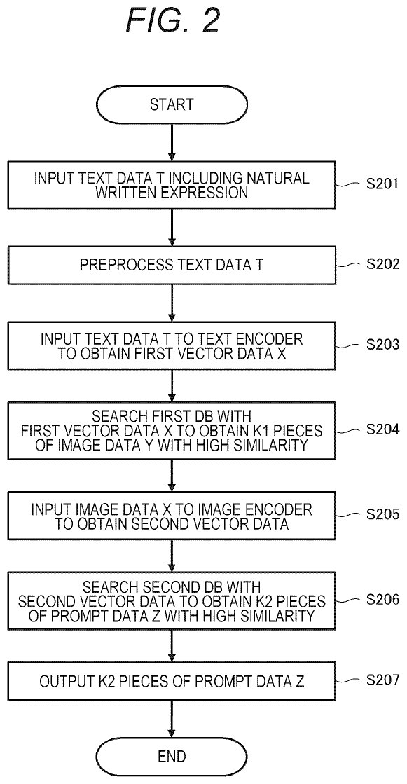

FIG. 2 illustrates an example of a processing procedure performed by the prompt optimization apparatus 100 in a form of a flowchart. Hereinafter, an operation of the prompt optimization apparatus 100 will be described with reference to FIG. 2.

First, text data T including a natural written expression as the input data to the Text2X model is input to the input unit 101 (step S201). For example, the input unit 101 may capture the text data key-input by the operator via the keyboard or the text data obtained by speech recognition of uttered voice of the operator, or may read the text data recorded in the medium.

Next, the preprocessing unit 102 performs preprocessing of normalizing the text data T input to the input unit 101 or dividing the text data T into units called tokens (step S202).

Next, the image search unit 103 converts the text data T output from the preprocessing unit 102 into the first vector data X by the text encoder 109 (step S203). The text encoder 109 of the previously trained VL model 108 can convert the input text data T into a vector representation having the same meaning for a human as that of the text data T on a common vector space (described above).

Then, the image search unit 103 searches the first database 106 with the obtained first vector data X, and acquires the image data Y paired with top K1 pieces of vector data having high similarity with the first vector data X (step S204). Therefore, the image search unit 103 can acquire the image data Y having high similarity with the text data T input at step S201.

Next, the prompt search unit 104 converts the K1 pieces of image data Y obtained by the image search unit 103 into the second vector data V by the image encoder 110 (step S205). The image encoder 110 of the previously trained VI model 108 can convert the input image data Y into a vector representation having the same meaning as that of the image data Y for a human on the common vector space (described above).

Then, the prompt search unit 104 searches the second database 107 with the obtained second vector data V, and acquires the prompt data Z paired with top K2 pieces of vector data having high similarity with the second vector data V (step S206). Therefore, the prompt search unit 104 can acquire the prompt data Z having high similarity with the image data Y acquired at step S204.

The output unit 105 outputs the K2 pieces of prompt data Z obtained by the prompt search unit 104 (step S207), and the prompt optimization apparatus 100 ends this processing.

The prompt data Z output at step S207 is input to, for example, the Text2X model (not illustrated). The prompt data Z output from the output unit 105 is easily interpreted by the Text2X model, and as a result, the Text2X model easily generates the image desired by the user.

The prompt optimization apparatus 100 can obtain the prompt data Z that is easily interpreted by the Text2X model via the image data Y having high similarity with the natural text data T directly input by a human by the processing procedure illustrated in FIG. 2. The prompt optimization apparatus 100 can convert the text data including a natural written expression into the prompt data in a short time and at a low cost by effectively utilizing an existing database obtained by collecting image data and prompt data according to the processing procedure illustrated in FIG. 2.

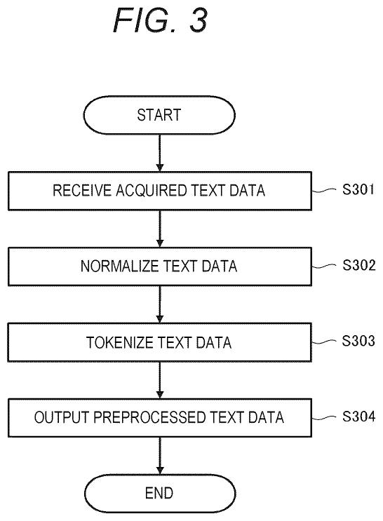

FIG. 3 illustrates an example of a processing procedure performed by the preprocessing unit 102 in a form of a flowchart. FIG. 3 illustrates the processing performed at step S202 in the flowchart illustrated in FIG. 2 in further detail. Hereinafter, an operation of the preprocessing unit 102 will be described with reference to FIG. 3.

First, the preprocessing unit 102 receives the text data input to the input unit 101 (step S301).

Next, the preprocessing unit 102 normalizes the text data input to the input unit 101 (step S302).

Here, normalization refers to, for example, conversion of notation including special characters such as environment-dependent characters and model-dependent characters, phonetic symbols, and other symbols into general alphabet as expressed in the following expression (1), conversion of representation by two characters such as “oreng”” to general one character such as “orange”, conversion of a full-width number such as “012” into a half-width number such as “012”, or conversion of a capital letter such as “Sony” into a small letter such as “sony”, and is processing for equating fluctuation and difference in various notations included in text data.

[Expression 1]

┌résumé┐→┌resume┐ (1)

Next, the preprocessing unit 102 performs tokenization of the text data normalized at step S302 (step S303).

Here, the token is a unit referred to as a token determined internally in advance such as “Dog”, “run”, “n”, and “ing” for “Dog running”, for example. At step S303, processing of dividing a character string input from the input unit 101 into such units referred to as tokens is performed.

Then, the preprocessing unit 102 outputs the preprocessed text data to the image search unit 103 in the subsequent stage (step S304).

### E. Configuration of VL Model

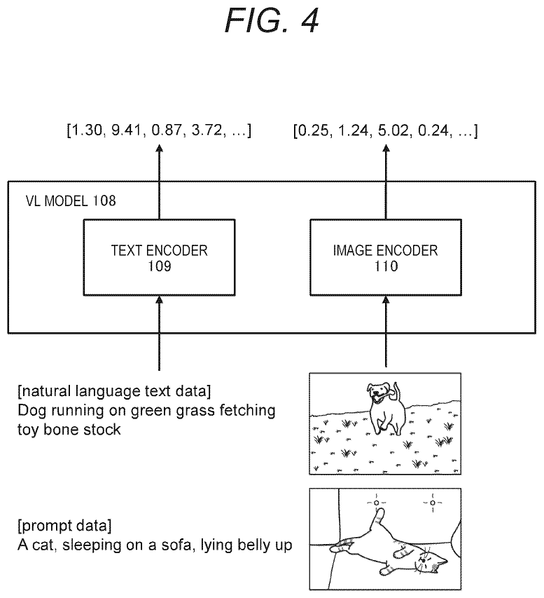

The VL model 108 is used when the image search unit 103 and the prompt search unit 104 convert the input expression into vector data. FIG. 4 illustrates a configuration example of the VL model 108. The VL model 108 is a model for simultaneously learning the image data and the text data and simultaneously learning features of both, thereby interpreting the data of these two modalities in the vector space in the same manner, and includes the text encoder 109 and the image encoder 110. A method of training the VL model 108 will be described in section H to be described.

The text encoder 109 has a function of converting (that is, embedding) any input text data into the vector representation. The text encoder 109 internally includes a deeply trained neural network (DNN) model. In contrast, the image encoder 110 has a function of converting (that is, embedding) any input image data into the vector representation. The image encoder 110 internally includes a deeply trained neural network (DNN) model. In the previously trained VL model 108, when the text data and the image data having the same meaning for a human are input, the text encoder 109 and the image encoder 110 map the text and the image to the same vector data on the common vector space.

The example illustrated in FIG. 4 illustrates an example in which the text data “Dog running on green grass fetching toy bone stock” including a natural written expression is input to the text encoder 109, image data having the same meaning as that of the text data is input to the image encoder 110, and each of the encoders 109 and 110 outputs text vector data and image vector data converted (embedded) into vector representation.

Furthermore, FIG. 4 illustrates an example in which the prompt data “A cat, sleeping on a sofa, lying belly up” is input to the text encoder 109, the image data having the same meaning as that of the prompt data is input to the image encoder 110, and each of the encoders 109 and 110 outputs text vector data and image vector data converted (embedded) into vector representation.

### F. Image Search Processing

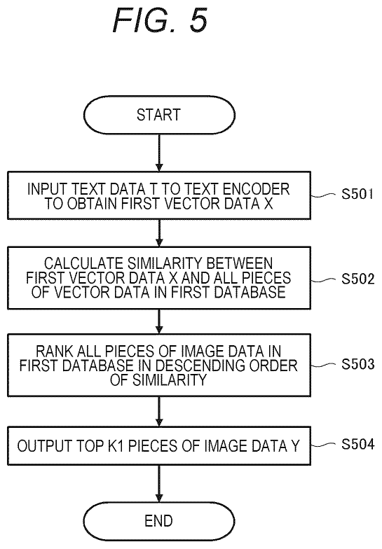

FIG. 5 illustrates an example of a processing procedure performed by the image search unit 103 in a form of a flowchart. The processing procedure illustrated in FIG. 5 corresponds to a detail of the processing performed at steps S203 and S204 in the flowchart illustrated in FIG. 2.

The image search unit 103 inputs the text data T input from the preprocessing unit 102 to the text encoder 109 (trained DNN model) of the previously trained VL model 108, and converts the text data T into the first vector data X (step S501). The text encoder 109 converts the input text data T into the vector representation having the same meaning as that of the text data T for a human on the common vector space (described above).

Next, the image search unit 103 calculates similarity between the first vector data X obtained at step S501 and all the vector data stored in the first database 106 in association with the image (step S502). Here, a commonly used method of calculating vector similarity such as cosine similarity may be used. The first database 106 stores a pair of image data and vector data having the same meaning as that of the image data for a human on the common vector space (described above).

Next, the image search unit 103 ranks all pieces of the image data stored in the first database 106 in descending order of similarity between the vector data calculated at step S502 (step S503). In this manner, the image search unit 103 can acquire top K1 pieces of image data Y having high similarity with the input text data T.

Then, the image search unit 103 outputs the top K1 pieces of image data Y having high similarity to the prompt search unit 104 in the subsequent stage (step S504).

### G. Prompt Search Processing

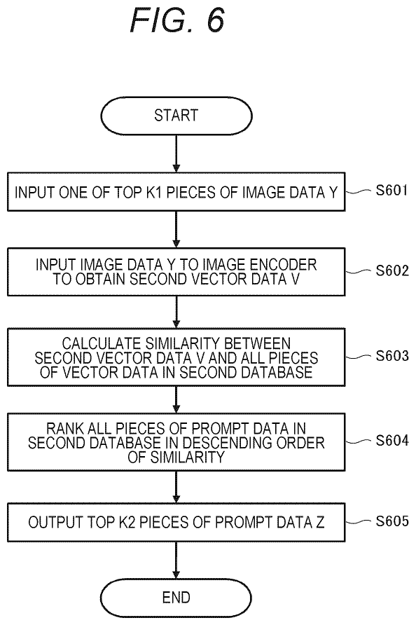

FIG. 6 illustrates an example of a processing procedure performed by the prompt search unit 104 in a form of a flowchart. The processing procedure illustrated in FIG. 6 corresponds to a detail of the processing performed at steps S205 and S206 in the flowchart illustrated in FIG. 2.

The prompt search unit 104 selects one piece of image data out of the K1 pieces of image data Y obtained as the output of the image search unit 103 (step S601). Note that, here, instead of selecting one piece of image data at a time, a plurality of pieces of image data may be selected at the same time and the similar processing may be repeatedly performed.

Next, the prompt search unit 104 inputs the image data Y selected at step S601 to the image encoder 110 of the previously trained VL model 108 and converts the image data Y into the second vector data V (step S602). The image encoder 110 converts the input image data Y into the vector representation having the same meaning as that of the image data Y selected by a human on the common vector space (described above).

Next, the prompt search unit 104 calculates similarity between the second vector data V obtained at step S602 and all pieces of the vector data stored in the second database 107 in association with the prompt (step S603). Here, a commonly used method of calculating vector similarity such as cosine similarity may be used. The second database 107 stores a pair of prompt data and vector data having the same meaning as that of the prompt data for a human on the common vector space (described above).

Next, the prompt search unit 104 ranks all pieces of the prompt data stored in the second database 107 in descending order of similarity between the pieces of vector data calculated at step S603 (step S604). In this manner, the prompt search unit 104 can acquire top K2 pieces of prompt data Z having high similarity with the input image data Y.

Then, the prompt search unit 104 outputs the top K2 pieces of prompt data having high similarity to the output unit 105 in the subsequent stage (step S605).

Here, in a case of selecting one piece of image data at step S601, the prompt search unit 104 is only required to output the top K2 pieces of prompt data in descending order of similarity between the pieces of vector data at step S605. Furthermore, in a case where the prompt search unit 104 selects a plurality of pieces of image data at step S601, this may output the prompt data one by one in order of similarity of each piece of image data while setting K2=1 at step S605.

Alternatively, the prompt search unit 104 may calculate a plurality of pieces of prompt data from the plurality of pieces of image data selected at step S601 and present a prompt with high similarity for each piece of image data, or may mix all pieces of the prompt data and sort the image data and the prompt data in descending order of similarity.

### H. Method of Training VL Model

The VL model is sometimes referred to as a vision-language pretraining model or a VLP model. The VL model is a model for simultaneously learning the image data and the text data and simultaneously learning features of both, thereby interpreting the two modalities in the vector space in the same manner. Examples of the existing VL model include a contrastive language-image pre-training (CLIP) model (refer to, for example, Non-Patent Document 3), The CLIP model is an open source infrastructure model that connects the image data and the text data.

As illustrated in FIGS. 1 and 4, the VL model 108 includes the text encoder 109 and the image encoder 110. The text encoder 109 and the image encoder 110 have a function of, when the text data and the image data having the same meaning for a human are input to the text encoder 109 and the image encoder 110, mapping (embedding) the text data and the image data to the same vector representation on the common vector space.

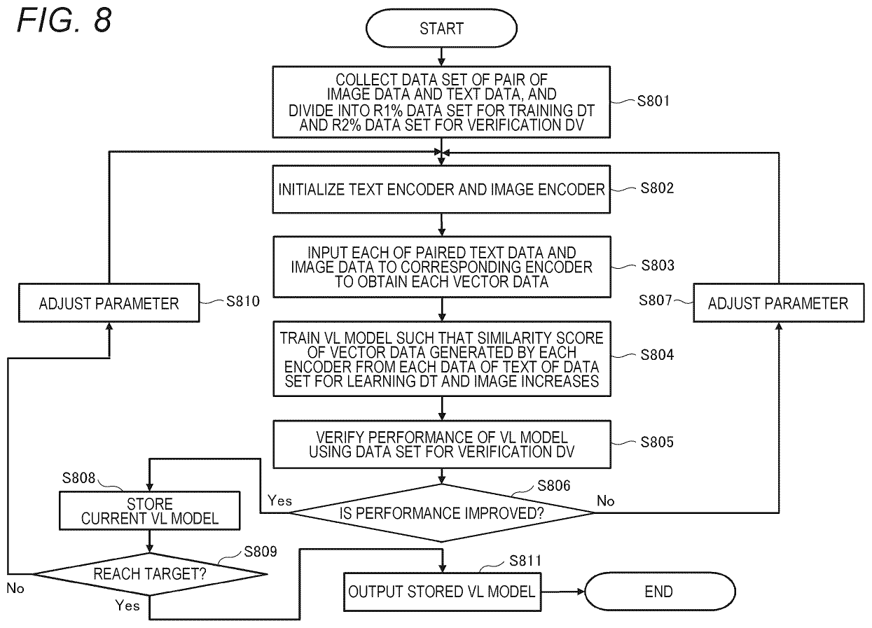

FIG. 8 illustrates a processing procedure of training the VL model 108 in a form of a flowchart. This training processing is performed by a model training apparatus. The model training apparatus includes, for example, a cloud server and the like, but may include the same information processing apparatus as the prompt optimization apparatus 100.

First, the model training apparatus reads a data set including a pair of image data and text data (step S801). Furthermore, the model training apparatus divides the read data set as that for training R1% and that for verification R2% for cross-modal verification. The model apparatus may determine the division in advance, and read the data set for training and for verification. Hereinafter, the data set for training is referred to as DT, and the data set for verification is referred to as DV.

Next, the model training apparatus initializes the text encoder 109 and the image encoder 110 (step S802). Here, initialization means that the parameters in the model are randomly set or set to a specific value to be read.

Next, the model training apparatus captures each pair of the image and the text read at step S801, causes the text encoder 109 to read the text data and the image encoder 110 to read the image, and obtains vector data (text vector data and image vector data) from each of them (step S803).

Next, the model training apparatus sets hyperparameters using the data for training DT and performs training of the VL model 108 (step S804). The hyperparameters are parameters determined mainly manually before training, and values that control behavior of various algorithms such as the number of epochs, a training rate, a threshold, a mini-batch size, the number of layers, and the number of neurons per layer, for example. At step S804, the model training apparatus performs training so as to increase a similarity score between the vector data (text vector data) obtained by the text encoder 109 from the text data and the vector data (image vector data) obtained by the image encoder 110 from the image, out of the data for training DT including a pair of the image and the text.

Next, the model training apparatus confirms a performance of the VL model 108 using the data for verification DV (step S805). That is, the model training apparatus confirms the performance of the VL model 108 on the basis of the similarity score between the vector data (text vector data) obtained by inputting the text data into the text encoder 109 and the vector data (image vector data) obtained by inputting the image into the image encoder 110 out of the data for verification DV including the image data and the text data. The cosine similarity may be calculated as the similarity score (same as above).

Then, the model training apparatus determines whether or not the performance of the VL model 108 calculated using the data for verification DV is improved as compared with that before training using the data for training DT (step S806).

Here, in a case where it is determined that the performance of the VL model 108 has not improved (No at step S806), the model training apparatus adjusts the hyperparameters (step S807), and then returns to step S802 to perform retraining of the VL model 108.

In contrast, in a case where it is determined that the performance of the VI model 108 has been improved (Yes at step S806), the model training apparatus stores current parameters of the VL model 108 (the text encoder 109 and the image encoder 110) (step S808).

Next, the model training apparatus confirms whether or not the VL model 108 has reached a target determination criterion using the data for verification DV (step S809).

In a case where the target determination criterion has not been reached (No at step S809), the model training apparatus adjusts the hyperparameters (step S810), and then returns to step S802 to perform the retraining of the VL model 108.

Furthermore, in a case where the target determination criterion has been reached (Yes at step S809), the model training apparatus outputs the parameters of the VL model 108 (the text encoder 109 and the image encoder 110) stored at step S808 (step S811), and ends this processing.

### I. Improvement in Method of Training VL Model

Here, the training processing of the VL model 108 performed at step S804 will be further described.

Examples of the existing VL model include the CLIP model (refer to Non-Patent Document 3) and further a cyclic CLIP (CyCLIP) model in which geometrically consistent expression in an image space and a text space is explicitly optimized (refer to Non-Patent Document 4). A method of further improving CyCLIP by finely tuning the text encoder 109 out of the VL model 108 is also proposed in the present specification.

For the training of the CLIP model, a cross-modal contrastive training loss L_{contra} between the text encoder 109 and the image encoder 110 defined by the following expression (2) is used. As expressed in the following expression (2), a learning target L_{contra} of CLIP is the cosine similarity between the text vector data and the image vector data to be paired.

$$\begin{matrix}[ Expression 2 ] & \\ {L}_{contra} = - {\sum }_{j = 1}^{N} log \frac{exp ( 〈 {I}_{j}^{e} , {T}_{j}^{e} 〉 / τ )}{{\sum }_{k} exp ( 〈 {I}_{j}^{e} , {T}_{k}^{e} 〉 / τ )} - {\sum }_{k = 1}^{N} log \frac{exp ( 〈 {I}_{k}^{e} , {T}_{k}^{e} 〉 / τ )}{{\sum }_{j} exp ( 〈 {I}_{j}^{e} , {T}_{k}^{e} 〉 / τ )} & ( 2 )\end{matrix}$$

Note that, in the above expression (2), it is assumed that a data set {(Iᵢ,Tᵢ)}^{N}ᵢ₌₁ including N pairs of image data Iᵢ and text data Tᵢ is used (i and N are positive integers, and 1≤i≤N is satisfied), and τ is a hyperparameter. Furthermore, <A,B> is calculation of the cosine similarity between the vector data A and B. Furthermore, T^{e} and I^{e} each represents vector representation converted (embedded) by each of the text encoder 109 and the image encoder 110 when paired text data and image data are input. This is similar in the following expressions (3) to (5).

Furthermore, in the learning target of CyCLIP, a loss L_{C-cyclic} regarding cross-modal consistency defined by the following expression (3), and a loss L_{I-cyclic} regarding in-modal consistency defined by the following expression (4) are added to the learning target L_{contra} Of CLIP represented by the above expression (2). As expressed by the following expressions (3) and (4), the learning target of CyCLIP is defined using the paired text vector data and image vector data.

$$\begin{matrix}[ Expression 3 ] & \\ {L}_{C - cyclic} = {\sum }_{j} {\sum }_{k} {( 〈 {I}_{j}^{e} , {T}_{k}^{e} 〉 - 〈 {I}_{k}^{e} , {T}_{j}^{e} 〉 )}^{2} & ( 3 )\end{matrix}$$

$$\begin{matrix}[ Expression 4 ] & \\ {L}_{I - cyclic} = {\sum }_{j} {\sum }_{k} {( 〈 {I}_{j}^{e} , {I}_{k}^{e} 〉 - 〈 {IT}_{k}^{e} , {T}_{j}^{e} 〉 )}^{2} & ( 4 )\end{matrix}$$

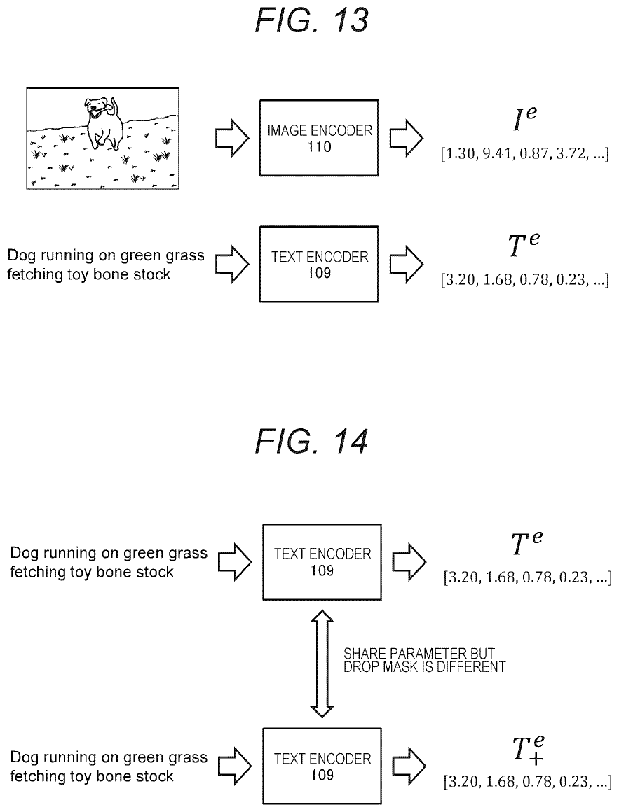

As a reference, FIG. 13 illustrates a specific example in which the text data “Dog running on green grass fetching toy bone stock” and image data of a dog running on green grass with a toy bone bar are input, and the text vector data Tₑ and the image vector data Iₑ are output from the text encoder 109 and the image encoder 110, respectively.

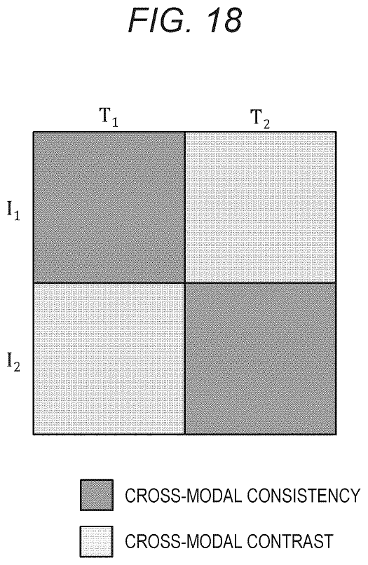

Furthermore, as further reference, FIG. 18 conceptually illustrates a cross-modal similarity matrix. Note that, for simplification, as the pair of text data and image data, there are only two pairs of {I₁, T₁} and {I₂, T₂}. On the matrix illustrated in FIG. 18, diagonal elements refer to the cosine similarity (cross-modal consistency) between matching pair of text data and image data, and off-diagonal elements refer to the cosine similarity (cross-modal contrast) of non-matching pair of text data and image data. It can be intuitively understood that decreasing the cross-modal consistency loss L_{C-cyclic} causes the cross-modal similarity matrix to be symmetric. Since training is performed in such a manner that the similarity of the off-diagonal pair becomes zero only with the learning target L_{contra} of CLIP, it is possible to expect symmetry of the cross-modal similarity matrix. However, since such a scenario does not actually occur, it is beneficial to explicitly optimize the cross-modal consistency loss L_{C-cyclic} (refer to Non-Patent Document 4).

In contrast, by optimizing the in-modal consistency loss L_{I-Cyclic}, geometric consistency between the text space and the entire image space can be improved. To calculate the in-modal consistency loss L_{I-Cyclic}, it is necessary to calculate the similarity <T^{e}ᵢ,T^{e}ⱼ> between the two pieces of text data, as can be seen from the above expression (4). Therefore, it is possible to hypothesize that accurately calculating the similarity of the text data generate benefit to the optimization of the in-modal consistency loss L_{I-Cyclic}.

Therefore, in the present specification, in order to improve the learning target of CyCLIP (described above), more accurate calculation of the cosine similarity between the text data is further proposed as a new learning target. This proposal uses simple contrastive sentence embedding (SimCSE), which is widely used in the art for systematic learning of caption representations. SimCSE also uses contrastive learning. In order to calculate the new learning target, the same text data is input twice to the text encoder 109 as illustrated in FIG. 14. Note that, by changing a drop mask of the text encoder 109 between the first and second inputs, different text vector data T^{e}ⱼ and T^{e}_{j,+} can be acquired from the same text data Tⱼ, and they form a positive pair of contrastive learning. For reference, FIG. 14 illustrates a specific example in which, when text data “Dog running on green grass fetching toy bone stock” is input, the text vector data T^{e} and T^{e}₊ are output from the text encoders 109 with different drop masks, respectively. Furthermore, different text data Tⱼ and Tₖ are sequentially input to the text encoder 109, and acquired text vector data T^{e}ⱼ and T^{e}_{k,+} form a negative pair. Then, an unsupervised SimCSE loss L_{S} defined by the following expression (5) is used as a new learning target.

$$\begin{matrix}[ Expression 5 ] & \\ {L}_{S} = {\sum }_{j} log \frac{exp ( 〈 {T}_{j}^{e} , {T}_{j , +}^{e} 〉 / τ )}{{\sum }_{k} exp ( 〈 {T}_{j}^{e} , {T}_{k , +}^{e} 〉 / τ )} & ( 5 )\end{matrix}$$

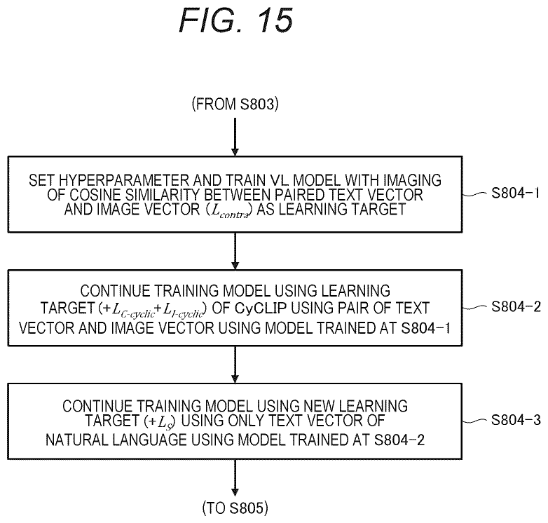

FIG. 15 illustrates the processing performed at step S804 in the flowchart illustrated in FIG. 8 in more detail. A subject of each processing described below is a model training apparatus.

First, the model training apparatus applies the training of the CLIP model to the VL model 108 (step S804-1). That is, the model training apparatus sets the hyperparameters, and performs training of the VL model so as to minimize the loss L_{contra} expressed in the above expression (2) so as to increase a similarity score between vector data (text vector data) obtained by the text encoder 109 from the text data and vector data (image vector data) obtained by the image encoder 110 from the image data, out of the data for training DT including a pair of the image data and the text data.

Next, the model training apparatus continues training of the CLIP model with respect to the VL model 108 using an additional term of the CyCLIP model (step S804-2). That is, the model training apparatus continues the training of the VI model so as to minimize a loss L_{contra}+L_{I-cyclic}+L_{C-cyclic} obtained by adding the loss L_{I-cyclic} regarding in-model consistency expressed in the above expression (3) and the loss L_{C-cyclic} regarding the cross-modal consistency expressed in the above expression (4), which are learning targets of CyCLIP, to the VL model trained at step S804-1 described above.

Moreover, the model training apparatus finely tunes the text encoder 109, thereby improving the CyCLIP model trained at step S804-2 described above (step S804-3). That is, the model training apparatus continues training of the VL model 108 so as to minimize L_{contra}+L_{I-cyclic}+L_{C-cyclic}+Lₛ obtained by further adding the loss Is for finely tuning the text encoder 109 expressed in the above expression (5) to the VI model trained at step S804-2 described above.

Thereafter, as described above, the model training apparatus checks the performance of the VI model 108 calculated using the data for verification DV (step S805), and continues training of the VL model 108 until the target performance of the VL model 108 can be acquired (step S809).

### J. Method of Creating First Database

The first database 106 is a database that stores a pair of the image data and the vector data having the same meaning as that of the image data for a human on the common vector space (described above). The image search unit 103 uses the first database 106 when searching for the image data having high similarity with the text data (having the same meaning as that of the text for a human) on the common vector space.

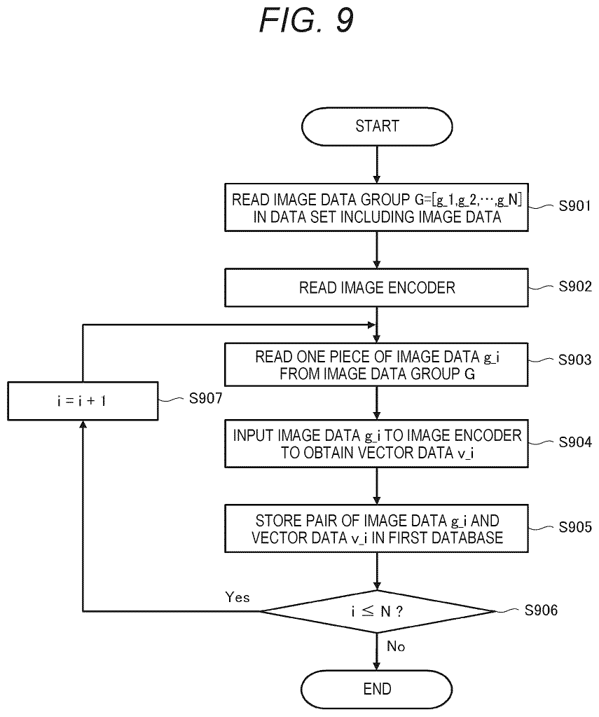

FIG. 9 illustrates a processing procedure for creating the first database 106 in a form of a flowchart. The database creation processing of the first database 106 is performed by a database creation apparatus. The database creation apparatus includes, for example, a cloud server and the like, but may include the same information processing apparatus as the prompt optimization apparatus 100.

First, the database creation apparatus reads a data set including any image data and sets an image data group therein as G (step S901). Here, it is assumed that the database creation apparatus reads N pieces of image data of G={g_1, g 2, . . . , and g_N}.

At step S901, as the data set including the image data, a data set including only the image data can be used, but a data set including a pair of the image data and data of modality other than the image can also be used. As the latter data set including the pair of the image data and the data of another modality, for example, a data set for training obtained by collecting a huge number of pairs of image data and caption data provided by a Large-scale Artificial Intelligence Open Network (LAION) can be used.

Next, the database creation apparatus reads the image encoder 110 of the previously trained VL model 108 (step S902).

Next, the database creation apparatus extracts one piece of image data g_i out of the image data group G read at step S901 (herein, i is a positive integer of 1 to N) (step S903).

Next, the database creation apparatus inputs the image data g_i to the image encoder 110, and obtains vector data v_i having the same meaning as that of the image data g_i for a human on the common vector space (described above) (step S904).

Then, the database creation apparatus stores a pair of the image data g_i and the vector data v_i in the first database 106 (step S905).

While i does not exceed N (Yes at step S906), the database creation apparatus increments i by 1 (step S907), and then returns to step S903 to repeatedly perform processing of extracting the image data g_i from the image data group G, acquiring the vector data v_i corresponding to the extracted image data g_i, and storing a pair of the image data g_i and the vector data v_i. Then, when i exceeds N (No at step S906), the database creation apparatus ends this processing, and the creation of the first database 106 is completed.

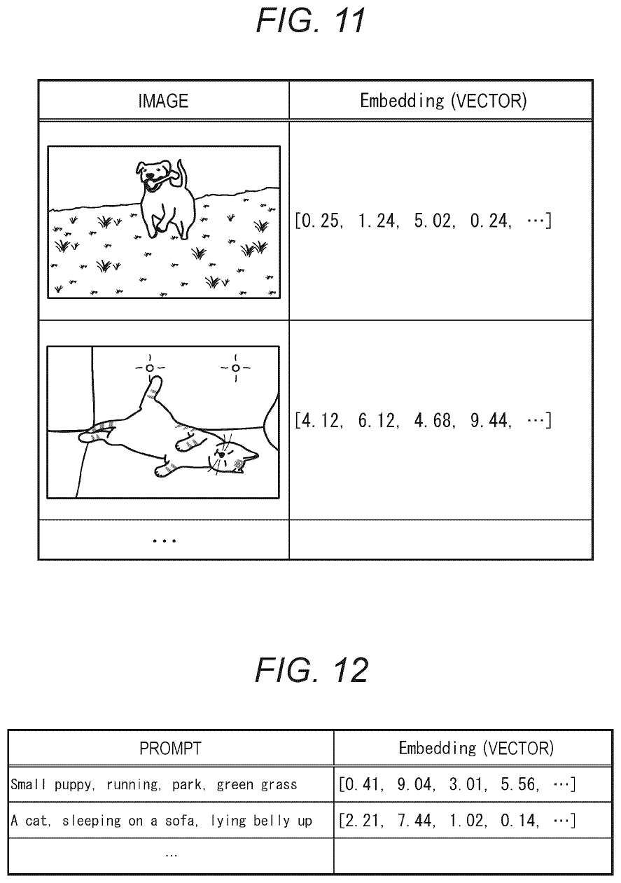

FIG. 11 illustrates a data example of the first database 106 created according to the processing procedure illustrated in FIG. 9. As illustrated in FIG. 11, the first database 106 stores a large number of records including a pair of image data and image vector data converted (embedded) from the image data into vector representation by the image encoder 110. In the example illustrated in FIG. 11, the first database 106 stores a record including a pair of a dog image and vector data [0.25, 1.24, 5.02, 0.24, . . . ] converted from the image data by the image encoder 110, a record including a pair of cat image data and vector data [4.12, 6.12, 4.68, 9.44, . . . ] converted from the image by the image encoder 110 and the like.

### K. Method of Creating Second Database

The second database 107 is a database that stores a pair of prompt data and vector data having the same meaning as that of the prompt data for a human on a common vector space (described above). The prompt search unit 104 uses the second database 107 when searching for the prompt data having high similarity (having the same meaning as that of the text for a human) with the image data on the common vector space.

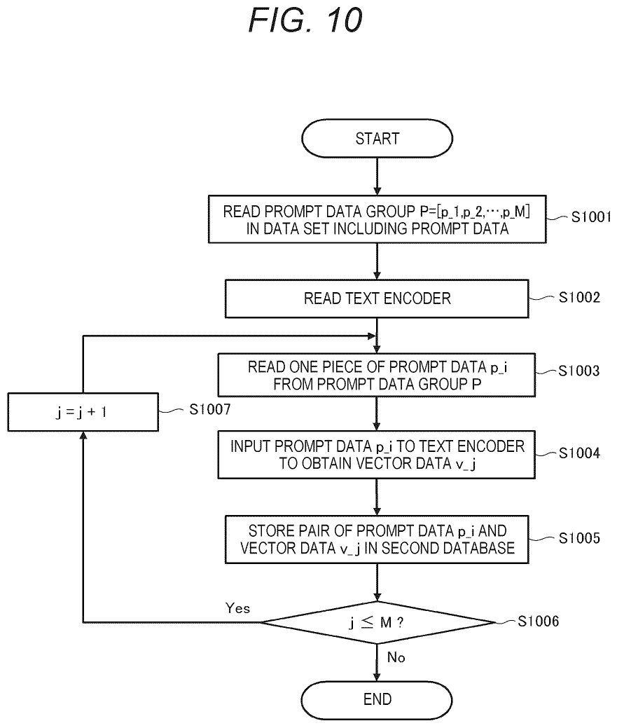

FIG. 10 illustrates a processing procedure for creating the second database 107 in a form of a flowchart. The database creation processing of the second database 107 is performed by the database creation apparatus. The database creation apparatus includes, for example, a cloud server and the like, but may include the same information processing apparatus as the prompt optimization apparatus 100.

First, the database creation apparatus reads a data set including any prompt data and sets a prompt data group therein as P (step S1001). Here, it is assumed that the database creation apparatus reads M pieces of prompt data of P={p_1, p_2, . . . , p_M}.

At step S1001, as the data set including the prompt data, a data set including only the prompt data can be used, but a data set including a pair of the prompt data and the data of the modality other than the prompt can also be used. As a latter data set including a pair of the prompt data and data of another modality, for example, DiffusionDB, which is a data set obtained by collecting the prompt data and the image data corresponding to the prompt data, can be used.

Next, the database creation apparatus reads the text encoder 109 of the previously trained VL model 108 (step S1002).

Next, the database creation apparatus extracts one piece of prompt data p_j out of the prompt data group P read at step S1001 (herein, j is a positive integer of 1 to M) (step S1003).

Next, the database creation apparatus inputs the prompt data p_j to the text encoder 109, and obtains vector data v_j having the same meaning as that of the prompt data p_j for a human on the common vector space (described above) (step S1004).

Then, the database creation apparatus stores a pair of the prompt data p_j and the vector data v_j in the second database 107 (step S1005).

While j does not exceed M (Yes at step S1006), the database creation apparatus increments j by 1 (step S1007), and then returns to step S1003 to repeatedly perform processing of extracting the prompt data p_j from the prompt data group P, acquiring the vector data v_j corresponding to the extracted prompt data p_j, and storing the pair of the prompt data p_j and the vector data v_j. Then, when j exceeds M (No at step S1006), the database creation apparatus ends this processing, and the creation of the second database 107 is completed.

FIG. 12 illustrates a data example of the second database 107 created according to the processing procedure illustrated in FIG. 10. As illustrated in FIG. 12, the second database 107 stores a large number of records including a pair of prompt data and text vector data converted (embedded) from the prompt data into vector representation by the text encoder 109. In the example illustrated in FIG. 12, the second database 107 stores a record including a pair of the prompt data “Small puppy, running, park, green grass” and the vector data [0.41, 9.04, 3.01, 5.56, . . . ] converted from the prompt by the text encoder 109, a record including a pair of the prompt data “A cat, sleeping on a sofa, lying belly up” and the vector data [2.21, 7.44, 1.02, 0.14, . . . ] converted from the prompt data by the text encoder 109 and the like.

### I. Configuration of Information Processing Apparatus

In this section K, a hardware configuration of an information processing apparatus that can operate as the prompt optimization apparatus 100 will be described. The information processing apparatus described in this section K can also operate as the model training apparatus that trains the VL model described in the section H described above and the database creation apparatus that creates the database described in the sections I and J described above.

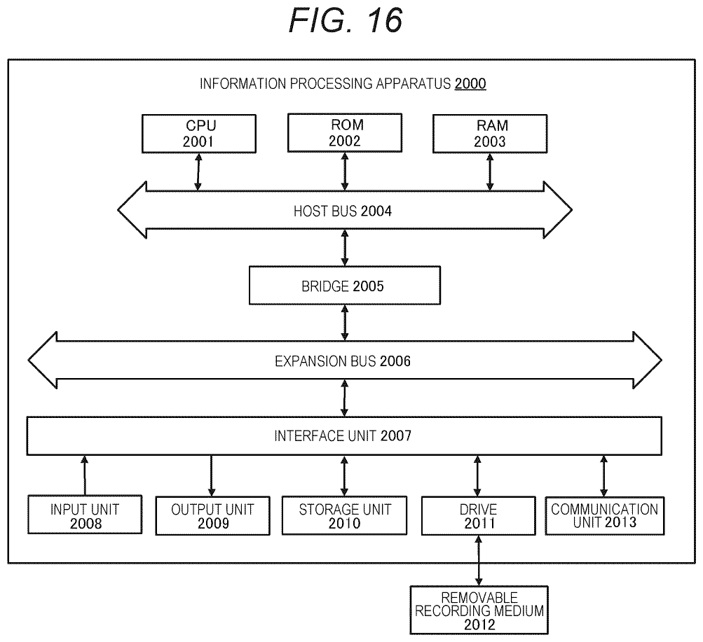

FIG. 16 illustrates a hardware configuration example of an information processing apparatus 2000. The information processing apparatus 2000 includes a central processing unit (CPU) 2001, a read only memory (ROM) 2002, a random access memory (RAM) 2003, a host bus 2004, a bridge 2005, an expansion bus 2006, an interface unit 2007, an input unit 2008, an output unit 2009, a storage unit 2010, a drive 2011, and a communication unit 2013.

The CPU 2001 controls an entire operation of the information processing apparatus 2000 in accordance with various programs. The ROM 2002 stores programs (such as a basic input/output system) and arithmetic parameters to be used by the CPU 2001 in a nonvolatile manner. The RAM 2003 is used to load a program to be used in execution of the CPU 2001 and temporarily store parameters such as work data that appropriately changes during program execution. Examples of the program to be loaded into the RAM 2003 and executed by the CPU 2001 include various application programs, an operating system (OS) and the like, for example.

The CPU 2001, the ROM 2002, and the RAM 2003 are interconnected by the host bus 2004 including a CPU bus or the like. Then, the CPU 2001 operates in conjunction with the ROM 2002 and the RAM 2003 to execute various application programs under an execution environment provided by the OS, thereby enabling various functions and services to be implemented. In a case where the information processing apparatus 2000 is a personal computer, the OS is, for example, Windows (registered trademark) of Microsoft Corporation, Unix (registered trademark), or a successor OS thereof. Furthermore, the application program includes a prompt optimization program for optimizing text data including natural written expression to prompt data suitable for input to the model, a model training program for performing model training processing, a database creation program for creating the first database 106 and the second database 107 and the like.

The host bus 2004 is connected to the expansion bus 2006 via the bridge 2005. The expansion bus 2006 is, for example, a peripheral component interconnect (PCI) bus or PCI Express, and the bridge 2005 is based on the PCI standard. Note that, the information processing apparatus 2000 does not necessarily have a configuration in which circuit components are separated by the host bus 2004, the bridge 2005, and the expansion bus 2006, and may be designed in such a manner that almost all circuit components are interconnected by a single bus (not illustrated).

The interface unit 2007 connects peripheral devices such as the input unit 2008, the output unit 2009, the storage unit 2010, the drive 2011, and the communication unit 2013, in accordance with the standard of the expansion bus 2006. Note that, all of the peripheral devices illustrated in FIG. 16 are not necessarily required, and the information processing apparatus 2000 may further include a peripheral device not illustrated. Furthermore, the peripheral device may be built in the main body of the information processing apparatus 2000, or some peripheral devices may be externally connected to the main body of the information processing apparatus 2000.

The input unit 2008 includes an input control circuit and the like that generates an input signal on the basis of an input from a user, and outputs the input signal to the CPU 2001. In a case where the information processing apparatus 2000 is a personal computer, the input unit 2008 may include a keyboard, a mouse, and a touch panel, and may further include a camera and a microphone. Furthermore, the output unit 2009 includes a display device such as a liquid crystal display (LCD) device, an organic electro-luminescence (EL) display device, or a light emitting diode (LED), for example.

The storage unit 2010 stores files such as programs (application, OS and the like) to be executed by the CPU 2001 and various pieces of data. Although the storage unit 2010 includes, for example, a mass storage such as a solid state drive (SSD) or a hard disk drive (HDD), this may include an external storage. For example, the first database 106 and the second database 107 used for optimization of the prompt data are stored in the storage unit 2010.

A removable storage medium 2012 is a cartridge-type storage medium such as a microSD card, for example. The drive 2011 performs reading and writing operations on a removable storage medium 113 loaded therein. The drive 2011 outputs data read from the removable recording medium 2012 to the RAM 2003 and the storage unit 2010, and writes data on the RAM 2003 and the storage unit 2010 into the removable recording medium 2012. For example, the first database 106 and the second database 107 used for optimization of the prompt data may be provided as the removable recording medium 2012.

The communication unit 2013 is a device that performs wireless communication such as Wi-Fi (registered trademark), Bluetooth (registered trademark), or a cellular communication network such as 4G or 5G. Furthermore, the communication unit 2013 also includes a terminal such as a universal serial bus (USB) or a high-definition multimedia interface (HDMI; registered trademark), and may further have a function of performing HDMI (registered trademark) communication with a USB device such as a scanner or a printer, a display and the like. For example, the first database 106 and the second database 107 used for optimization of the prompt data may be arranged on a cloud and available via the communication unit 2013.

The information processing apparatus 2000 can operate as the prompt optimization apparatus 100 by executing a prompt optimization program for optimizing text data including natural written expression to prompt data suitable for input to the model. Furthermore, two or more information processing apparatuses 2000 can be combined to configure the prompt optimization apparatus 100. Furthermore, the information processing apparatus 2000 can also operate as a model training apparatus by executing a model training program for performing model training processing, and operate as a database creation apparatus by executing a database creation program for creating the first database 106 and the second database 107.

### INDUSTRIAL APPLICABILITY

The present disclosure is described above in detail with reference to the specific embodiments. However, the present disclosure should not be construed as being limited to the above-described embodiments, and those skilled in the art obviously can make modifications and substitutions of the embodiments without departing from the gist of the present disclosure. Furthermore, the effects described in the present specification are merely examples, and the effects brought by the present disclosure are not limited, and there may be additional effects that are not described in the present specification.

In the present specification, an embodiment has been mainly described in which the present disclosure is applied to image generative AI to convert text data including a natural written expression input from a human into prompt data suitable for input to the AI, but the gist of the present disclosure is not limited thereto. The present disclosure can be applied to AI that generates data of various modalities other than images, and can convert text data input from a human into prompt data suitable for input to the AI. Furthermore, the present disclosure is applied to various types of AI that perform generation and recognition/inference, and acquires prompt data that can obtain a better result from the AI, whereby the ability of the AI can be improved without performing large-scale training or retraining.

In short, the present disclosure has been described in an illustrative manner, and the contents described in the present specification should not be interpreted in a limited manner. To determine the gist of the present disclosure, claims should be taken into consideration.

The series of processing described in the present specification can be executed by hardware, software, or a configuration in which hardware and software are combined. In a case where the processing is executed by software, a program in which a processing sequence regarding implementation of the present disclosure is recorded is installed in a memory incorporated in dedicated hardware in a computer to be executed. It is also possible to install a program in a general-purpose computer capable of executing various types of processing and cause the computer to execute the processing regarding implementation of the present disclosure.

The program can be stored in advance in a recording medium provided in the computer, such as an HDD, an SSD, or a ROM as a recording medium, for example. Alternatively, the program can be temporarily or permanently stored in a removable recording medium such as a flexible disk, a compact disc read only memory (CD-ROM), a magneto optical (MO) disk, a digital versatile disc (DVD), a Blu-ray Disc (BD) (registered trademark), a magnetic disk, or a universal serial bus (USB) memory. By using such removable recording medium, it is possible to provide the program regarding implementation of the present disclosure as so-called packaged software.

Furthermore, the program may be transferred from a download site to a computer in a wireless or wired manner via a network such as a wide area network (WAN) typified by a cellular network, a local area network (LAN), or the Internet. The computer can receive the program thus transferred and cause the program to be installed in a mass storage such as an HDD or an SSD in the computer.

Note that, the present disclosure may also have the following configurations.
(1) An information processing apparatus including:
an acquisition unit that acquires text data;
an image search unit that searches for image data corresponding to first vector data on the basis of the first vector data obtained by converting the text data; and
a prompt search unit that searches for prompt data corresponding to second vector data on the basis of the second vector data obtained by converting the image data.
(2) The information processing apparatus according to (1) described above, further including:
a preprocessing unit that generates preprocessed data by performing preprocessing of normalizing the text data or dividing the text data into token units, in which
the image search unit searches for the image data on the basis of the preprocessed data.
(3) The information processing apparatus according to (1) or (2) described above, in which
the image search unit acquires the first vector data converted from the text data using a text encoder of a previously trained VL model.
(4) The information processing apparatus according to any one of (1) to (3) described above, in which
the image search unit searches for image data paired with vector data having high similarity with the first vector data in a first database that stores a pair of image data and vector data.
(5) The information processing apparatus according to (4) described above, in which
each piece of image data read from a data set including image data is converted into vector data by an image encoder of a previously trained VL model, a pair of original image data and converted vector data is stored, and the first database is created.
(5-1) The information processing apparatus according to (5) described above, in which
a data set obtained by collecting a pair of image data and text data is used as the data set including image data.
(6) The information processing apparatus according to any one of (1) to (5) described above, in which
the prompt search unit acquires the second vector data converted from the image data using an image encoder of a previously trained VL model.
(7) The information processing apparatus according to any one of (1) to (6) described above, in which
the prompt search unit searches for prompt data paired with vector data having high similarity with the second vector in a second database that stores a pair of prompt data and vector data.
(8) The information processing apparatus according to (7) described above, in which
each piece of prompt data read from a data set including prompt data is converted into vector data by a text encoder of a previously trained VL model, a pair of original prompt data and converted vector data is stored, and the second database is created.
(8-1) The information processing apparatus according to (8) described above, in which
a data set (DiffusionDB) in which a pair of prompt data and image data is collected is used as the data set including prompt data.
(9) The information processing apparatus according to any one of (1) to (8) described above, further including:
an input unit that inputs voice data, in which
the acquisition unit obtains text data from the voice data by speech recognition.
(10) The information processing apparatus according to any one of (1) to (9) described above, further including:
an output unit that outputs the prompt data searched by the prompt search unit to a generation apparatus that generates information based on the prompt data by using a trained generative model.
(10-1) The information processing apparatus according to (10) described above, in which
the generative model is a Text2X model.
(11) The information processing apparatus according to any one of (3), (5), (6), and (8), in which
training of the VL model is performed using a learning target of CLIP, then the training of the VL model is continued while adding a learning target of CyCLIP, and the training of the VL model is continued while further adding a learning target for finely tuning the text encoder.
(12) An information processing method including:
an acquisition step of acquiring text data;
an image searching step of searching for image data corresponding to first vector data on the basis of the first vector data obtained by converting the text data; and
a prompt searching step of searching for prompt data corresponding to second vector data on the basis of the second vector data obtained by converting the image data.
(13) A computer program described in a computer readable format to cause a computer to function as:
an acquisition unit that acquires text data;
an image search unit that searches for image data corresponding to first vector data on the basis of the first vector data obtained by converting the text data; and
a prompt search unit that searches for prompt data corresponding to second vector data on the basis of the second vector data obtained by converting the image data.
(14) A generation system including:
an acquisition unit that acquires text data;
a previously trained VL model including a text encoder and an image encoder;
a first database that stores a pair of image data and vector data;
a second database that stores a pair of prompt data and vector data;
an image search unit that searches the first database for image data paired with vector data having high similarity with first vector data converted from the text data using the text encoder;
a prompt search unit that searches the second database for prompt data paired with vector data having high similarity with second vector data converted from the image data using the image encoder; and
a generation unit that inputs the prompt data searched by the prompt search unit into a trained generative model and generates information based on the prompt data.
(14-1) The generation system according to (14) described above, in which
the generative model is a Text2X model.

### REFERENCE SIGNS LIST

100 Prompt optimization apparatus
101 Input unit
102 Preprocessing unit
103 Image search unit
104 Prompt search unit
105 Output unit
106 First database
107 Second database
108 VL model
109 Text encoder
110 Image encoder
2000 Information processing apparatus
2001 CPU
2002 ROM
2003 RAM
2004 Host bus
2005 Bridge
2006 Expansion bus
2007 Interface unit
2008 Input unit
2009 Output unit
2010 Storage unit
2011 Drive
2012 Removable recording medium
2013 Communication unit

1. An information processing apparatus comprising:
an acquisition unit that acquires text data;
an image search unit that searches for image data corresponding to first vector data on a basis of the first vector data obtained by converting the text data; and
a prompt search unit that searches for prompt data corresponding to second vector data on a basis of the second vector data obtained by converting the image data.

2. The information processing apparatus according to claim 1, further comprising:
a preprocessing unit that generates preprocessed data by performing preprocessing of normalizing the text data or dividing the text data into token units, wherein
the image search unit searches for the image data on a basis of the preprocessed data.

3. The information processing apparatus according to claim 1, wherein
the image search unit acquires the first vector data converted from the text data using a text encoder of a previously trained vision language (VL) model.

4. The information processing apparatus according to claim 1, wherein
the image search unit searches for image data paired with vector data having high similarity with the first vector data in a first database that stores a pair of image data and vector data.

5. The information processing apparatus according to claim 4, wherein
each piece of image data read from a data set including image data is converted into vector data by an image encoder of a previously trained VL model, a pair of original image data and converted vector data is stored, and the first database is created.

6. The information processing apparatus according to claim 1, wherein
the prompt search unit acquires the second vector data converted from the image data using an image encoder of a previously trained VL model.

7. The information processing apparatus according to claim 1, wherein
the prompt search unit searches for prompt data paired with vector data having high similarity with the second vector in a second database that stores a pair of prompt data and vector data.

8. The information processing apparatus according to claim 7, wherein
each piece of prompt data read from a data set including prompt data is converted into vector data by a text encoder of a previously trained VL model, a pair of original prompt data and converted vector data is stored, and the second database is created.

9. The information processing apparatus according to claim 1, further comprising:
an input unit that inputs voice data, wherein
the acquisition unit obtains text data from the voice data by speech recognition.

10. The information processing apparatus according to claim 1, further comprising:
an output unit that outputs the prompt data searched by the prompt search unit to a generation apparatus that generates information based on the prompt data by using a trained generative model.

11. The information processing apparatus according to claim 3, wherein
training of the VL model is performed using a learning target of CLIP, then the training of the VL model is continued while adding a learning target of CyCLIP, and the training of the VL model is continued while further adding a learning target for finely tuning the text encoder.

12. An information processing method comprising:
an acquisition step of acquiring text data;
an image searching step of searching for image data corresponding to first vector data on a basis of the first vector data obtained by converting the text data; and
a prompt searching step of searching for prompt data corresponding to second vector data on a basis of the second vector data obtained by converting the image data.

13. A computer program described in a computer readable format to cause a computer to function as:
an acquisition unit that acquires text data;
an image search unit that searches for image data corresponding to first vector data on a basis of the first vector data obtained by converting the text data; and
a prompt search unit that searches for prompt data corresponding to second vector data on a basis of the second vector data obtained by converting the image data.

14. A generation system comprising:
an acquisition unit that acquires text data;
a previously trained VL model including a text encoder and an image encoder;
a first database that stores a pair of image data and vector data;
a second database that stores a pair of prompt data and vector data;
an image search unit that searches the first database for image data paired with vector data having high similarity with first vector data converted from the text data using the text encoder;
a prompt search unit that searches the second database for prompt data paired with vector data having high similarity with second vector data converted from the image data using the image encoder; and
a generation unit that inputs the prompt data searched by the prompt search unit into a trained generative model and generates information based on the prompt data.
